(19) United States
(12) Patent Application Publication
(10) Pub. No.: US 2019/0170498 A1
(43) Pub. Date: Jun. 6, 2019

(54) POSITION DETECTION DEVICE

(71) Applicant: DENSO CORPORATION, Kariya-city (JP)

(72) Inventors: Takasuke ITO, Kariya-city (JP); Yoshiyuki KONO, Kariya-city (JP); Tomoyuki TAKIGUCHI, Kariya-city (JP); Sadahito FUKUMORI, Kariya-city (JP)

(21) Appl. No.: 16/267,631

(22) Filed: Feb. 5, 2019

Related U.S. Application Data
(63) Continuation of application No. PCT/JP2017/029294, filed on Aug. 14, 2017.

(30) Foreign Application Priority Data
Aug. 23, 2016 (JP) 2016-162957
Feb. 3, 2017 (JP) 2017-18249

(51) Int. Cl. G01B 7/30; G01D 5/245; G01D 11/24; G01D 5/14; H01R 43/02

(52) U.S. Cl. CPC G01B 7/30; G01D 5/245; H01R 43/0221; G01D 5/145; H01R 43/0214; G01D 11/245

(57) ABSTRACT

An IC package includes a magnetic detection element, multiple lead lines electrically connected to the magnetic detection element, and multiple terminal lines weldable to the lead lines respectively. A first welding portion, in which a first lead line of the multiple lead lines is welded to a first terminal line of the multiple terminal lines, is not on vertical lines that pass through second welding portions in which the second lead lines of the multiple lead lines are welded to the second terminal lines of the multiple terminal lines respectively. The second lead lines are adjacent to the first lead line. The vertical lines are orthogonal to center axes of the second lead lines.

### CROSS REFERENCE TO RELATED APPLICATION

The present application is a continuation application of International Patent Application No. PCT/JP2017/029294 filed on Aug. 14, 2017, which designated the U.S. and claims the benefit of priority from Japanese Patent Applications No. 2016-162957 filed on Aug. 23, 2016 and No. 2017-018249 filed on Feb. 3, 2017. The entire disclosures of all of the above applications are incorporated herein by reference.

### TECHNICAL FIELD

The present disclosure relates to a position detection device.

### BACKGROUND

Conventionally, a position detection device is used for detecting the position of an object such as a rotational axis of a movable body.

### SUMMARY

According to one aspect of the present disclosure, a position detection device includes a detector to detect an intensity relevant to a magnetic field. The detector is connected with lead lines. The lead lines are further coupled to terminal lines respectively.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic view illustrating an electronic control throttle device to which a position detection device according to a first embodiment of the present disclosure is applied;

FIG. 2 is a schematic view illustrating the position detection device according to the first embodiment of the present disclosure;

FIG. 3 is a partial enlarged view illustrating the position detection device according to the first embodiment of the present disclosure;

FIG. 4 is a partial enlarged view illustrating a position detection device according to a second embodiment of the present disclosure;

FIG. 5 is a diagram seen from a direction of an arrow V in FIG. 4;

FIG. 6 is a partial enlarged view illustrating a position detection device according to a third embodiment of the present disclosure; and

FIG. 7 is a diagram seen from a direction of an arrow VII in FIG. 6.

### DETAILED DESCRIPTION

To begin with, an exemplified configuration of a position detecting device will be described as follows.

The position detection device is configured to detect the position of a detection target. The position detection device includes an IC package. In a conceivable configuration, the IC package includes two magnetic detection elements configured to detect variation in a magnetic field caused by movement of the detection target. The IC package is electrically connected with a sensor terminal. A connector portion is further provided to enable an external terminal to electrically connect with the sensor terminal.

In the position detection device as exemplified, the IC package may have four lead lines. The four lead lines may include two signal lead lines electrically connected to two magnetic detection elements, a power supply lead common for the two magnetic detection elements, and a ground lead line common for the two magnetic detection elements. In a conceivable configuration, among the lead lines, the power supply lead line and the ground lead line may be provided between the two signal lead lines. In addition, the power supply lead line and the ground lead line may be welded to the power supply terminal line and the ground lead line, respectively. In the conceivable configuration, the point at which the power supply lead line is welded to the power supply terminal line is adjacent to the point at which the ground lead line is welded to the ground terminal line. In the conceivable configuration, spatters caused during welding would thus cause a short circuit. Thus, the short circuit could possibly cause a welding failure.

In consideration of those issues, a position detection device may have a configuration to restrict a short circuit in lead lines and terminal lines.

In one example, a position detection device includes an IC package and multiple terminal lines. The IC package include multiple lead lines projected from a sealing portion and electrically connected to a magnetic detection element in the sealing portion. The terminal lines are weldable to the lead lines respectively. The lead lines include a first lead line and second lead lines. The second lead lines are adjacent to the first lead line. The first lead line is welded to a first terminal line of the terminal lines at a first welding portion. The second lead lines are welded to second terminal lines of the terminal lines at second welding portions respectively. In this example, the first welding portion is not on vertical lines, which pass through the second welding portions and are orthogonal to center axes of the second lead lines respectively.

Presumably, when the first lead line is welded to the first terminal line, spatters may occur. The configuration of this example could enable to restrict the spatters caused when the first lead line is welded to the first terminal line from being attached to the second lead lines, the second terminal lines, and the second welding portions. Accordingly, this example could enable to restrict occurrence of a short circuit between combinations of lead lines and terminal lines when being welded.

Embodiments of the present disclosure will be described below with reference to the drawings. Substantially the same components of embodiments are given the same reference numerals and descriptions thereof are omitted.

### First Embodiment

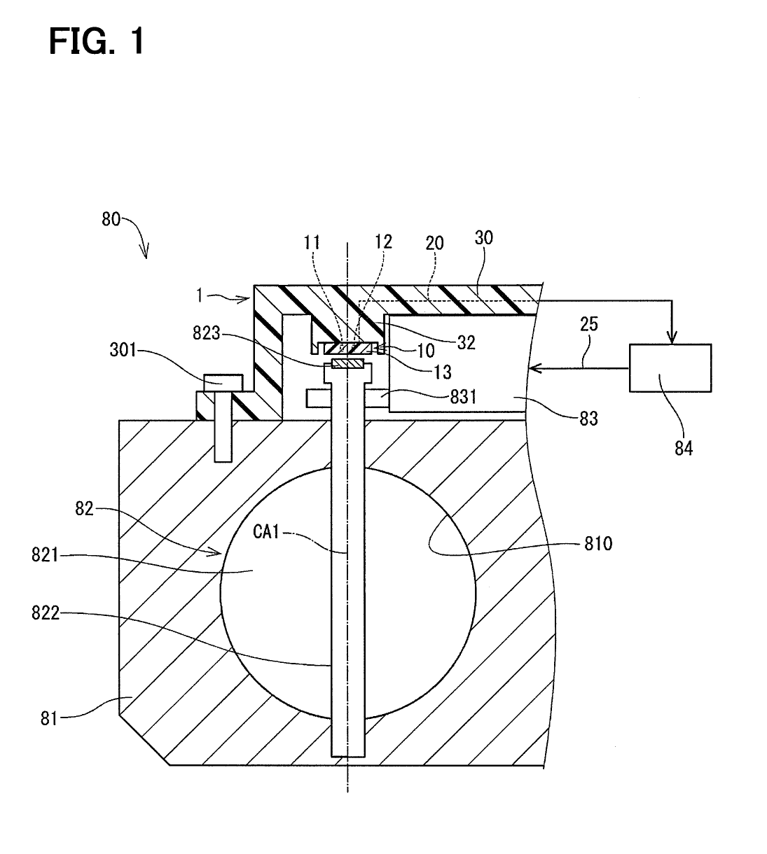

A position detection device according to a first embodiment will be described with reference to FIGS. 1 to 3. A rotation angle detection device 1, which is “the position detection device” according to the first embodiment, is used in an electronic control throttle device 80 that controls the amount of intake air supplied to an engine installed in a vehicle (not illustrated).

First, the structure of the electronic control throttle device 80 will be described. As illustrated in FIG. 1, the electronic control throttle device 80 includes a valve housing 81, a throttle valve 82, a motor 83, the rotation angle detection device 1, an electronic control unit (referred to below as the ECU) 84, and the like.

The valve housing 81 includes an intake air passage 810 through which air is introduced to the engine. The throttle valve 82 is provided in the intake air passage 810.

The throttle valve 82 includes a valve member 821 as “a detection target” and a valve shaft 822.

The valve member 821 is a substantially disk-shaped member having an outer diameter slightly smaller than the inner diameter of the intake air passage 810. The valve member 821 is fixed to the valve shaft 822. Both sides of the valve shaft 822 are rotationally supported by the valve housing 81. This causes the valve member 821 to rotate about a rotation shaft CA1 of the valve shaft 822 as a rotation shaft. A magnet 823 is provided in an end portion of the valve shaft 822 close to the rotation angle detection device 1. When the valve shaft 822 rotates, a magnetic field in the vicinity of an IC package 10 included in the rotation angle detection device 1 changes.

The motor 83 is accommodated in the rotation angle detection device 1. The motor 83 is coupled to the valve shaft 822 via a coupling member 831. The motor 83 generates a rotational torque to rotate the valve shaft 822. The motor 83 is electrically connected to the ECU 84.

The ECU 84 is a small computer including a CPU as computation unit, a ROM and a RAM as storage unit, input-output unit, and the like. The ECU 84 determines the opening of the throttle valve 82 according to the travel state of the vehicle in which the electronic control throttle device 80 is installed and the operational state of the driver of the vehicle. The ECU 84 outputs electric power to the motor 83 according to the opening of the throttle valve 82. This controls the opening of the throttle valve 82 and adjusts the amount of intake air supplied to the engine.

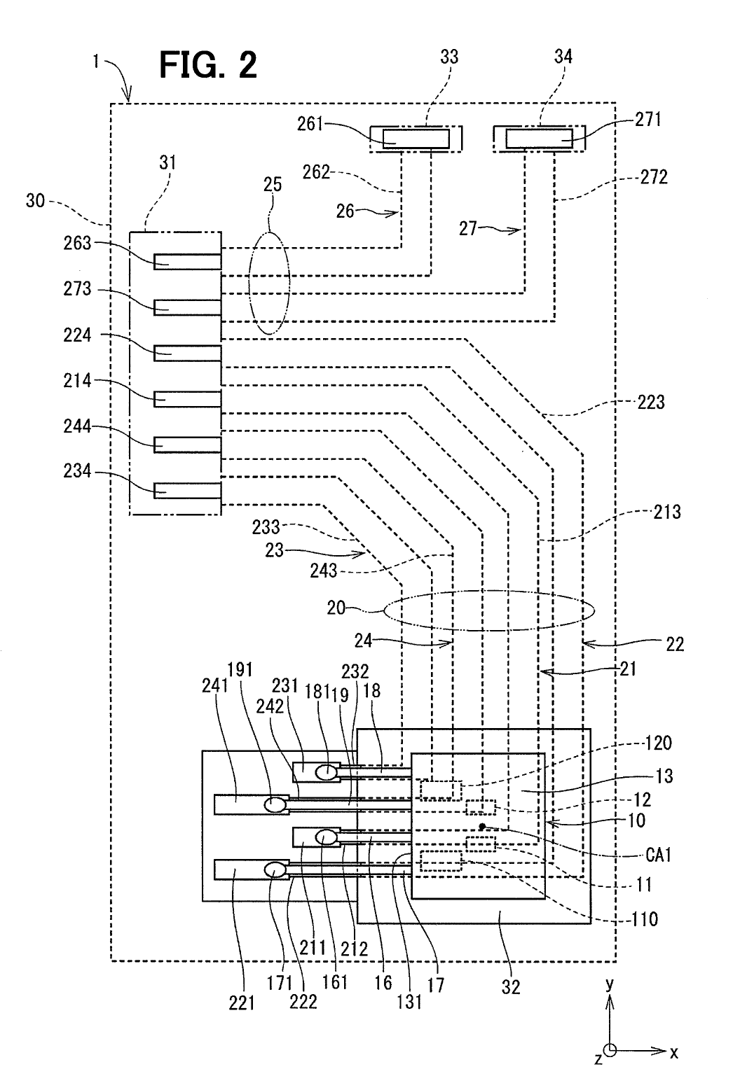

The rotation angle detection device 1 includes the IC package 10, a sensor terminal 20, a motor terminal 25, and a sensor housing 30. The rotation angle detection device 1 is provided in the part of the valve housing 81 close to the end portion of the valve shaft 822 in which the magnet 823 is provided. FIG. 2 represents the sensor housing 30 using a dotted line and schematically illustrates the shapes and the disposition of the IC package 10, the sensor terminal 20, and the motor terminal 25.

The IC package 10 is an IC package referred to as a two-system output type or a two-output type and includes a first magnetic detection element 11, a first signal processing circuit 110, a second magnetic detection element 12, a second signal processing circuit 120, a sealing portion 13, a power supply lead line 16, which is “the lead line” and “the first lead line”, a first signal lead line 17, which is “the lead line” and “the second lead line”, a second signal lead line 18, which is “the lead line”, and a ground lead line 19, which is “the lead line” and “the second lead line”. The IC package 10 is provided in the vicinity of the magnet 823 on the rotation shaft CA1, as illustrated in FIG. 1.

The first magnetic detection element 11 is configured to output a first signal that depends on a first component of the magnetic field formed by the magnet 823 or the strength of the first component. The first magnetic detection element 11 is electrically connected to the power supply lead line 16, the ground lead line 19, and the first signal processing circuit 110.

The first signal processing circuit 110 is electrically connected to the first signal lead line 17. The first signal processing circuit 110 processes the first signal output by the first magnetic detection element 11.

The second magnetic detection element 12 is configured to output a second signal that depends on a second component different from the first component of the magnetic field formed by the magnet 823 or the strength of the second component. The second magnetic detection element 12 is electrically connected to the power supply lead line 16, the ground lead line 19, and the second signal processing circuit 120.

The second signal processing circuit 120 is electrically connected to the second signal lead line 18. The second signal processing circuit 120 processes the second signal output by the second magnetic detection element 12.

The sealing portion 13 is used to seal the first magnetic detection element 11, the first signal processing circuit 110, the second magnetic detection element 12, and the second signal processing circuit 120 and formed in a substantially rectangular parallelepiped.

The power supply lead line 16 is formed so as to project in a direction substantially orthogonal to the rotation shaft CA1 from a planar end face 131 of the sealing portion 13. The current toward the first magnetic detection element 11 and the second magnetic detection element 12 from a power supply (not illustrated) flows through the power supply lead line 16.

A coordinate plane is set in FIG. 2 to conveniently describe the shapes and disposition of the IC package 10, the sensor terminal 20, and the motor terminal 25. The axis parallel with the direction in which the power supply lead line 16 projects is defined to be the x-axis and the direction in which the power supply lead line 16 projects is defined to be the negative direction of the x-axis. That is, the power supply lead line 16 projects in the negative direction of the x-axis from the end face 131. In addition, the axis orthogonal to the x-axis and the rotation shaft CA1 is defined to be the y-axis. In addition, the axis orthogonal to the x-axis and the y-axis is defined to be the z-axis.

The first signal lead line 17 is formed so as to project in the negative direction of the x-axis from the end face 131 of the sealing portion 13. The first signal output by the first signal processing circuit 110 is configured to be output to the outside through the first signal lead line 17.

The second signal lead line 18 is formed so as to project in the negative direction of the x-axis from the end face 131 of the sealing portion 13. The second signal output by the second signal processing circuit 120 is configured to be output to the outside through the second signal lead line 18.

The ground lead line 19 is formed so as to project in the negative direction of the x-axis from the end face 131 of the sealing portion 13. A current that has flowed through the first magnetic detection element 11 and the second magnetic detection element 12 flows to the ground through the ground lead line 19.

In the IC package 10 according to the first embodiment, the first signal lead line 17, the power supply lead line 16, the ground lead line 19, and the second signal lead line 18 are arranged on the end face 131 in this order so as to project in the negative direction of the x-axis.

The sensor terminal 20 includes a power supply terminal line 21, which is “the terminal line” and “the first terminal line”, a first signal terminal line 22, which is “the terminal line” and “the second terminal line”, a second signal terminal line 23, which is “the terminal”, and a ground terminal line 24, which is “the terminal line” and “the second terminal line”. The sensor terminal 20, which is a member having a relatively large conductivity, is formed so as to extend from the vicinity of the power supply lead line 16 or the like to a connector portion 31 of the sensor housing 30 through the opposite side of the magnet 823 of the IC package 10. The sensor terminal 20 is formed integrally with the sensor housing 30 by insert molding of the sensor housing 30 (see FIG. 1).

The power supply terminal line 21 includes a power supply welding terminal 211, which is “the first welding terminal”, a power supply connection portion 212, a power supply insert portion 213, and a power supply connector terminal 214.

The power supply welding terminal 211 is a relatively wide portion provided in a position in which welding to the power supply lead line 16 is enabled. The power supply welding terminal 211 is formed so as to be positioned at the tail end of the power supply terminal line 21 and extend in the plus direction of the x-axis. The side of the power supply welding terminal 211 opposite to the tail end of the power supply terminal line 21 is connected to the power supply connection portion 212.

The power supply connection portion 212 has a width smaller than that of the power supply welding terminal 211. The power supply connection portion 212 is formed so as to extend in the positive direction of the x-axis from the power supply welding terminal 211. The side of the power supply connection portion 212 opposite to the side connected to the power supply welding terminal 211 is connected to the power supply insert portion 213.

The power supply insert portion 213 is inserted into the sensor housing 30. The power supply insert portion 213 is formed so as to extend in the positive direction of the y-axis through the opposite side of the magnet 823 of the IC package 10 and then extend in the negative direction of the x-axis as illustrated in FIG. 2. The side of the power supply insert portion 213 opposite to the side connected to the power supply connection portion 212 is connected to the power supply connector terminal 214.

The power supply connector terminal 214 is positioned in the connector portion 31. The power supply connector terminal 214 is formed so as to be electrically connectable to a power supply (not illustrated) via an external connector (not illustrated). The current toward the first magnetic detection element 11 and the second magnetic detection element 12 from the power supply flows through the power supply terminal line 21.

The first signal terminal line 22 includes a first signal welding terminal 221, which is “the second welding terminal”, a first signal connection portion 222, which is “the second connection portion”, a first signal insert portion 223, and a first signal connector terminal 224.

The first signal welding terminal 221 is a relatively wide portion provided in a position in which welding to the first signal lead line 17 is enabled. The first signal welding terminal 221 is formed so as to be positioned at the tail end of the first signal terminal line 22 and extend in the positive direction of the x-axis. The first signal welding terminal 221 is provided in a position more apart from the end face 131 of the sealing portion 13 than the power supply welding terminal 211. The side of the first signal welding terminal 221 opposite to the tail end of the first signal terminal line 22 is connected to the first signal connection portion 222.

The first signal connection portion 222 has a width smaller than that of the first signal welding terminal 221. The first signal connection portion 222 is formed so as to extend in the positive direction of the x-axis from the first signal welding terminal 221. The first signal connection portion 222 is formed to become longer than the power supply connection portion 212. The side of the first signal connection portion 222 opposite to the side connected to the first signal welding terminal 221 is connected to the first signal insert portion 223.

The first signal insert portion 223 is inserted into the sensor housing 30. The first signal insert portion 223 is formed so as to extend in the positive direction of the y-axis through the opposite side of the magnet 823 of the IC package 10 and then extend in the negative direction of the x-axis as illustrated in FIG. 2. The side of the first signal insert portion 223 opposite to the side connected to the first signal connection portion 222 is connected to the first signal connector terminal 224.

The first signal connector terminal 224 is positioned in the connector portion 31. The first signal connector terminal 224 is formed so as to be electrically connectable to the ECU 84 via an external connector. The first signal terminal line 22 outputs the first signal that has been output by the first signal processing circuit 110 to the ECU 84.

The second signal terminal line 23 includes a second signal welding terminal 231, a second signal connection portion 232, a second signal insert portion 233, and a second signal connector terminal 234.

The second signal welding terminal 231 is a relatively wide portion provided in a position in which welding to the second signal lead line 18 is enabled. The second signal welding terminal 231 is formed so as to be positioned at the tail end of the second signal terminal line 23 and extend in the positive direction of the x-axis. The second signal welding terminal 231 is provided in a position closer to the end face 131 of the sealing portion 13 than a ground welding terminal 241, which is “the second welding terminal” of the ground terminal line 24. The side of the second signal welding terminal 231 opposite to the tail end of the second signal terminal line 23 is connected to the second signal connection portion 232.

The second signal connection portion 232 has a width smaller than that of the second signal welding terminal 231. The second signal connection portion 232 is formed so as to extend in the positive direction of the x-axis from the second signal welding terminal 231. The second signal connection portion 232 is formed so as to become shorter than a ground connection portion 242, which is “the second connection portion” of the ground terminal line 24. The side of the second signal connection portion 232 opposite to the side connected to the second signal welding terminal 231 is connected to the second signal insert portion 233.

The second signal insert portion 233 is inserted into the sensor housing 30. The second signal insert portion 233 is formed so as to extend in the positive direction of the y-axis through the opposite side of the magnet 823 of the IC package 10 and then extend in the negative direction of the x-axis as illustrated in FIG. 2. The side of the second signal insert portion 233 opposite to the side connected to the second signal connection portion 232 is connected to the second signal connector terminal 234.

The second signal connector terminal 234 is positioned in the connector portion 31. The second signal connector terminal 234 is formed so as to be electrically connectable to the ECU 84 via an external connector. The second signal terminal line 23 outputs the second signal output by the second signal processing circuit 120 to the ECU 84.

The ground terminal line 24 includes the ground welding terminal 241, the ground connection portion 242, a ground insert portion 243, and a ground connector terminal 244.

The ground welding terminal 241 is a relatively wide portion provided in a position in which welding to the ground lead line 19 is enabled. The ground welding terminal 241 is formed so as to be positioned at the tail end of the ground terminal line 24 and extend in the positive direction of the x-axis. The ground welding terminal 241 is provided in a position more apart from the end face 131 of the sealing portion 13 than the power supply welding terminal 211 and the second signal welding terminal 231 that are adjacent. The side of the ground welding terminal 241 opposite to the tail end of the ground terminal line 24 is connected to the ground connection portion 242.

The ground connection portion 242 has a width smaller than that of the ground welding terminal 241. The ground connection portion 242 is formed so as to extend in the positive direction of the x-axis from the ground welding terminal 241. The ground connection portion 242 is formed so as to become longer than the power supply connection portion 212 and the second signal connection portion 232. The side of the ground connection portion 242 opposite to the side connected to the ground welding terminal 241 is connected to the ground insert portion 243.

The ground insert portion 243 is inserted into the sensor housing 30. The ground insert portion 243 is formed so as to extend in the positive direction of the y-axis through the opposite side of the magnet 823 of the IC package 10 and then extend in the negative direction of the x-axis as illustrated in FIG. 2. The side of the ground insert portion 243 opposite to the side connected to the ground connection portion 242 is connected to the ground connector terminal 244.

The ground connector terminal 244 is positioned in the connector portion 31. The ground connector terminal 244 is formed so as to be electrically connectable to the ground via an external connector. A current that has flowed through the first magnetic detection element 11 and the second magnetic detection element 12 flows to the ground through the ground terminal line 24.

In the sensor terminal 20, the widths in the y-axis direction of the first signal connection portion 222 and the ground connection portion 242 are smaller than the width in the y-axis direction of the power supply welding terminal 211 sandwiched between the first signal connection portion 222 and the ground connection portion 242. Accordingly, the first signal connection portion 222 and the power supply welding terminal 211 extend in the x-axis direction apart from each other and the power supply welding terminal 211 and the ground connection portion 242 extend in the x-axis direction apart from each other.

In addition, the width in the y-axis direction of the ground connection portion 242 is smaller than the width in the y-axis direction of the second signal welding terminal 231 adjacent to the ground connection portion 242 in the y-axis direction. Accordingly, the second signal welding terminal 231 and the ground connection portion 242 extend in the x-axis direction apart from each other.

The motor terminal 25 includes two motor terminal lines 26 and 27. The motor terminal lines 26 and 27 include motor connection terminals 261 and 271, motor insert portions 262 and 272, and motor connector terminals 263 and 273, respectively.

The motor connection terminals 261 and 271 are provided in sockets 33 and 34 of the sensor housing 30. The sockets 33 and 34 are formed so as to engage with the motor 83. This enables the motor connection terminals 261 and 271 to be connected to external terminals (not illustrated) of the motor 83. The motor connection terminals 261 and 271 are connected to the motor insert portions 262 and 272.

The motor insert portions 262 and 272 are inserted into the sensor housing 30. The end portions of the motor insert portions 262 and 272 opposite to the sides connected to the motor connection terminals 261 and 271 are connected to the motor connector terminals 263 and 273.

The motor connector terminals 263 and 273 are positioned in the connector portion 31. The motor terminal 25 can supply electric power supplied by the power supply to the motor 83 via the connector portion 31.

The sensor housing 30 is a hollow member formed in a substantially rectangular parallelepiped. The part of the sensor housing 30 close to the valve housing 81 has an opening as illustrated in FIG. 1 so as to accommodate the motor 83 therein. The sensor housing 30 is fixed to the valve housing 81 through a bolt 301 so as to disable relative movement. The sensor housing 30 has a stage 32 on which the IC package 10 can be mounted. Accordingly, the IC package 10 is provided in the vicinity of the magnet 823 as illustrated in FIG. 1. A part of the sensor terminal 20 is inserted into the stage 32.

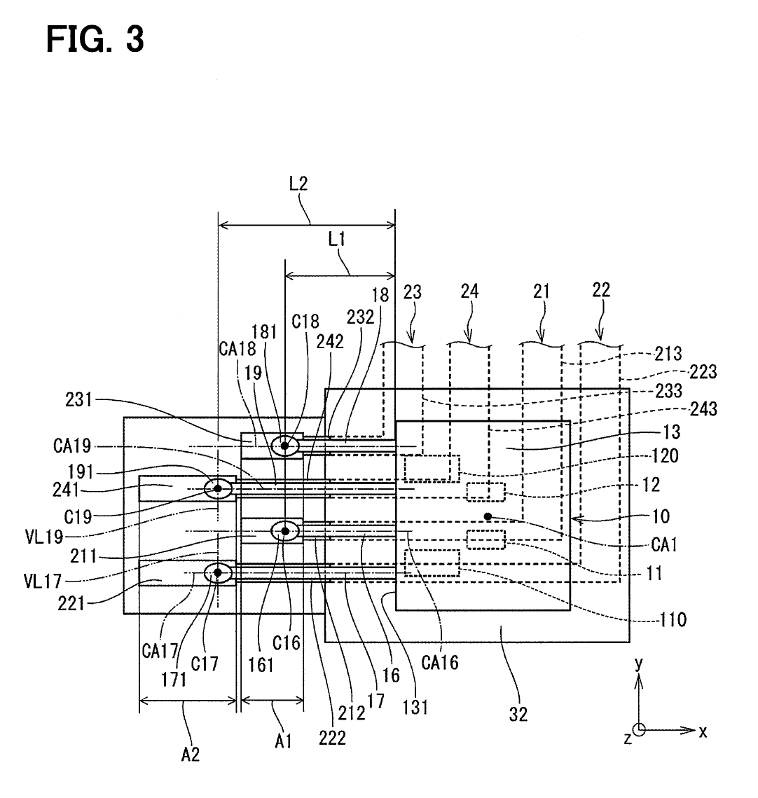

Next, the features of the rotation angle detection device 1 according to the first embodiment will be described with reference to FIG. 3.

Four lead lines projecting in the negative direction of the x-axis from the end face 131 of the IC package 10 have different lengths. Specifically, as illustrated in FIG. 3, the length of the first signal lead line 17 is larger than that of the power supply lead line 16. In addition, the length of the ground lead line 19 is longer than those of the power supply lead line 16 and the second signal lead line 18. That is, one of the four lead lines has a length different from those of two adjacent lead lines. In the first embodiment, the length of the first signal lead line 17 is the same as that of the ground lead line 19. In addition, the length of the power supply lead line 16 is the same as that of the second signal lead line 18.

Since the lengths of the four lead lines have such a relationship, for example, a distance L1 from a center C16 of a welding portion 161 (as “the first welding portion”) in which the power supply lead line 16 is welded to the power supply welding terminal 211 to the end face 131 is smaller than a distance L2 from a center C17 of the welding portion 171 (as “the second welding portion”) in which the first signal lead line 17 is welded to the first signal welding terminal 221 to the end face 131. In addition, the relationship between the distance L1 from the center C16 of the welding portion 161 to the end face 131 and the distance L2 from a center C19 of the welding portion 191 (as “the second welding portion”) in which the ground lead line 19 is welded to the ground welding terminal 241 to the end face 131 is also the same. In addition, the relationship between the distance L1 from a center C18 of the welding portion 181 in which the second signal lead line 18 is welded to the second signal welding terminal 231 to the end face 131 and the distance L2 from the center C19 of the welding portion 191 to the end face 131 is also the same.

That is, the welding portion 161 is present in a place not on a vertical line VL17, which passes through the welding portion 171 and is orthogonal to a center axis CA17, and not on a vertical line VL19, which passes through the welding portion 191 and is orthogonal to a center axis CA19. Specifically, the welding portion 161 is present in a place deviating from the welding portion 171 and the welding portion 191 that have center axes adjacent to a center axis CA16. In addition, the welding portion 181 is present in a place not on the vertical line VL19, which passes through the welding portion 191 and is orthogonal to the center axis CA19. Specifically, the welding portion 181 is preset in a place deviating from the welding portion 191 that has a center axis adjacent to a center axis CA18.

When welding terminals of the four terminal lines are seen along the x-axis, the power supply welding terminal 211 and the second signal welding terminal 231 deviate from the first signal welding terminal 221 and the ground welding terminal 241.

Specifically, as illustrated in FIG. 3, a region A1 along the x-axis in which the power supply welding terminal 211 and the second signal welding terminal 231 are positioned and a region A2 along the x-axis in which the first signal welding terminal 221 and the ground welding terminal 241 are positioned do not overlap with each other.

In the rotation angle detection device 1 according to the first embodiment, the IC package 10 has four lead lines. The four lead lines are welded to corresponding terminal lines. As illustrated in FIG. 3, points at which the four lead lines are welded to corresponding terminal lines deviate from each other.

In addition, the width in the y-axis direction of the first signal connection portion 222 and the width in the y-axis direction of the ground connection portion 242 are smaller than the width in the y-axis direction of the power supply welding terminal 211. Accordingly, the insulating space that can be obtained around the power supply welding terminal 211 becomes relatively larger than the case in which the width in the y-axis direction of the first signal connection portion 222 and the width in the y-axis direction of the ground connection portion 242 are the same as the width in the y-axis direction of the power supply welding terminal 211. In addition, the width in the y-axis direction of the ground connection portion 242 is smaller than the width in the y-axis direction of the second signal welding terminal 231. Accordingly, the insulating space that can be obtained around the second signal welding terminal 231 becomes larger than the case in which the width in the y-axis direction of the ground connection portion 242 is the same as the width in the y-axis direction of the second signal welding terminal 231.

For example, spatters caused and splattered peripherally when the power supply lead line 16 is welded to the power supply terminal line 21 are not easily attached to the first signal lead line 17, the ground lead line 19, the first signal terminal line 22, the ground terminal line 24, and the welding portions 171 and 191. Accordingly, a short circuit between the power supply lead line 16 and the power supply terminal line 21, a short circuit between the first signal lead line 17 and the first signal terminal line 22, and a short circuit between the ground lead line 19 and the ground terminal line 24 can be restricted. This is also true of a short circuit between the ground lead line 19 and the ground terminal line 24, a short circuit between the power supply lead line 16 and the power supply terminal line 21, or a short circuit between the second signal lead line 18 and the second signal terminal line 23.

In the rotation angle detection device 1 according to the first embodiment, it is possible to restrict spatters caused during welding from being attached to unintended portions in this way. This enables to restrict occurrence of a short circuit of a combination of a lead line and a terminal line that do not correspond to each other.

In addition, in the rotation angle detection device 1 according to the first embodiment, the power supply welding terminal 211 and the second signal welding terminal 231 are formed in the region A1 and the first signal welding terminal 221 and the ground welding terminal 241 are formed in the region A2 along the x-axis. That is, the first signal welding terminal 221, the power supply welding terminal 211, the ground welding terminal 241, and the second signal welding terminal 231 are provided so as not to be adjacent to each other. Accordingly, the point at which one lead line is welded to one terminal line surely deviates from the point at which another lead line adjacent to the one lead line is welded to another terminal line to be welded to the other lead line. Accordingly, it is possible to surely restrict occurrence of a short circuit of a combination of a lead line and a terminal line that do not correspond to each other due to spatters caused during welding.

### Second Embodiment

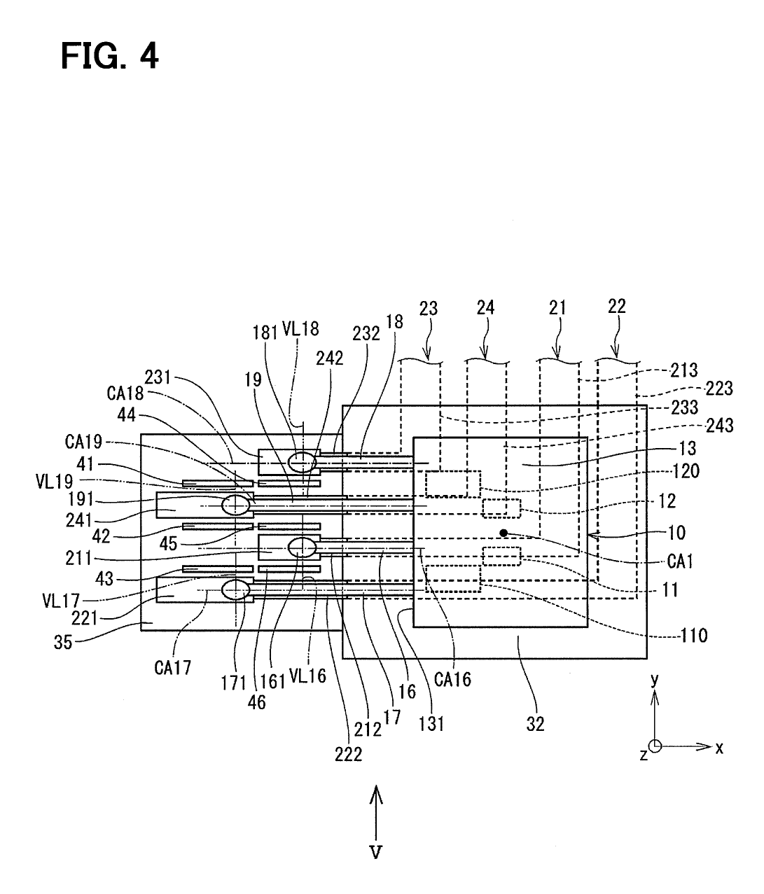

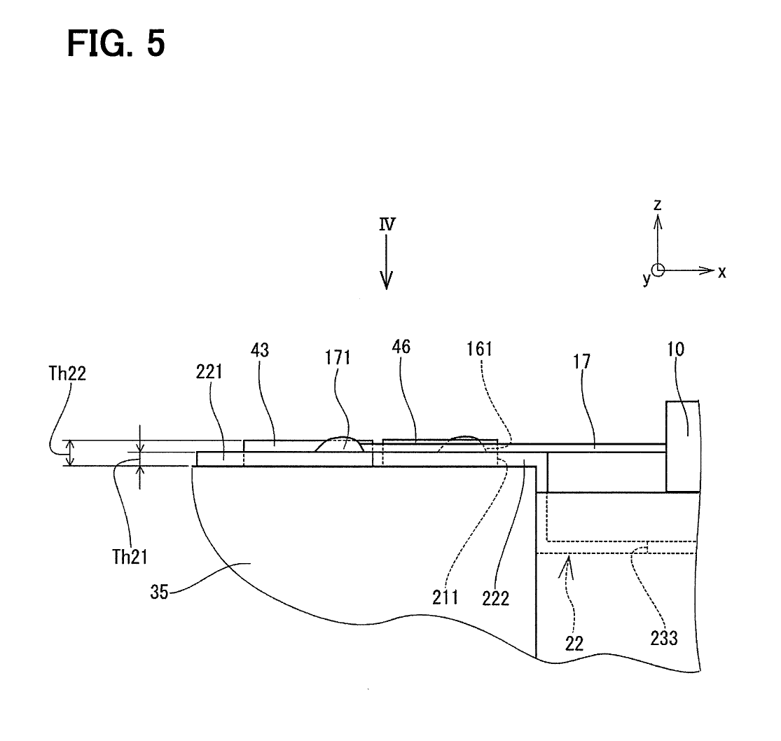

A position detection device according to a second embodiment will be described with reference to FIGS. 4 and 5. The second embodiment is different from the first embodiment in that wall bodies adjacent to welding terminals are provided.

A partial enlarged view of a rotation angle detection device according to a second embodiment is illustrated in FIG. 4. The rotation angle detection device according to the second embodiment includes the IC package 10, the sensor terminal 20, the motor terminal 25, the sensor housing 30, covers 41, 42, 43, and 44, and covers 45 and 46 as “the wall bodies”.

The covers 41, 42, 43, 44, 45, and 46 are portions, formed integrally with the sensor housing 30, that are made of resin material. The covers 41, 42, 43, 44, 45, and 46 are insulative and provided on a placement table 35 on which the power supply welding terminal 211, the first signal welding terminal 221, the second signal welding terminal 231, and the ground welding terminal 241 are placed.

The cover 41 is provided on the side of the ground welding terminal 241 positioned in the positive direction of the y-axis. The cover 42 is provided on the side of the ground welding terminal 241 positioned in the negative direction of the y-axis. More specifically, the covers 41 and 42 are provided on the vertical line VL19, which passes through the welding portion 191 and is orthogonal to the center axis CA19 of the ground lead line 19, as illustrated in FIG. 4. At this time, the cover 41 and the cover 42 are provided so as to sandwich the ground lead line 19 on the ground welding terminal 241. The heights of the covers 41 and 42 along the z-axis are larger than the height of the ground welding terminal 241 along the z-axis. The heights of the covers 41 and 42 along the z-axis are preferably larger than the height along the z-axis when the ground welding terminal 241 and the ground lead line 19 overlap with each other.

The cover 43 is provided on the side of the first signal welding terminal 221 positioned in the positive direction of the y-axis. More specifically, the cover 43 is provided on the vertical line VL17, which passes through the welding portion 171 and is orthogonal to the center axis CA17 of the first signal lead line 17, as illustrated in FIG. 4. As illustrated in FIG. 5, which is a partial enlarged view seen from the direction of the arrow V in FIG. 4, a height Th22 of the cover 43 along the z-axis is larger than a height Th21 of the first signal welding terminal 221 along the z-axis. The height of the cover 43 along the z-axis is preferably larger than the height along the z-axis when the first signal welding terminal 221 and the first signal lead line 17 overlap with each other.

The cover 44 is provided on the side of the second signal welding terminal 231 positioned in the negative direction of the y-axis. More specifically, the cover 44 is provided on the vertical line VL18, which passes through the welding portion 181 and is orthogonal to the center axis CA18 of the second signal lead line 18, as illustrated in FIG. 4. The height of the cover 44 along the z-axis is larger than the height of the second signal welding terminal 231 along the z-axis. The height of the cover 44 along the z-axis is preferably larger than the height along the z-axis when the second signal welding terminal 231 and the second signal lead line 18 overlap with each other.

The cover 45 is provided on the side of the power supply welding terminal 211 positioned in the positive direction of the y-axis. The cover 46 is provided on the side of the power supply welding terminal 211 positioned in the negative direction of the y-axis. More specifically, the covers 45 and 46 are provided on a vertical line VL16, which passes through the welding portion 161 and is orthogonal to the center axis CA16 of the power supply lead line 16, as illustrated in FIG. 4. At this time, the cover 45 and the cover 46 are provided so as to sandwich the power supply lead line 16 on the power supply welding terminal 211. In addition, the cover 45 is provided to sandwich the ground lead line 19 together with the cover 41.

The heights of the covers 45 and 46 along the z-axis are larger than the height of the power supply welding terminal 211 along the z-axis. Specifically, as illustrated in FIG. 5, the height Th22 of the cover 46 along the z-axis is larger than the height Th21 of the power supply welding terminal 211 along the z-axis. The heights of the covers 45 and 46 along the z-axis are preferably larger than the height along the z-axis when the power supply welding terminal 211 and the power supply lead line 16 overlap with each other.

In the rotation angle detection device according to the second embodiment, the covers 41, 42, 43, 44, 45, and 46 can surely restrict spatters from being splattered peripherally when the lead lines are welded to the terminal lines. Accordingly, the second embodiment can surely restrict occurrence of a short circuit of a combination of a lead line and a terminal line that do not correspond to each other in addition to obtaining the effects of the first embodiment.

In addition, in the rotation angle detection device according to the second embodiment, two covers are provided so as to sandwich one lead line. This enables to restrict the deformation of lead lines such as the bending of lead lines that may be caused when, for example, welding terminals are welded to lead lines. Accordingly, a short circuit between adjacent lead lines can be surely restricted.

### Third Embodiment

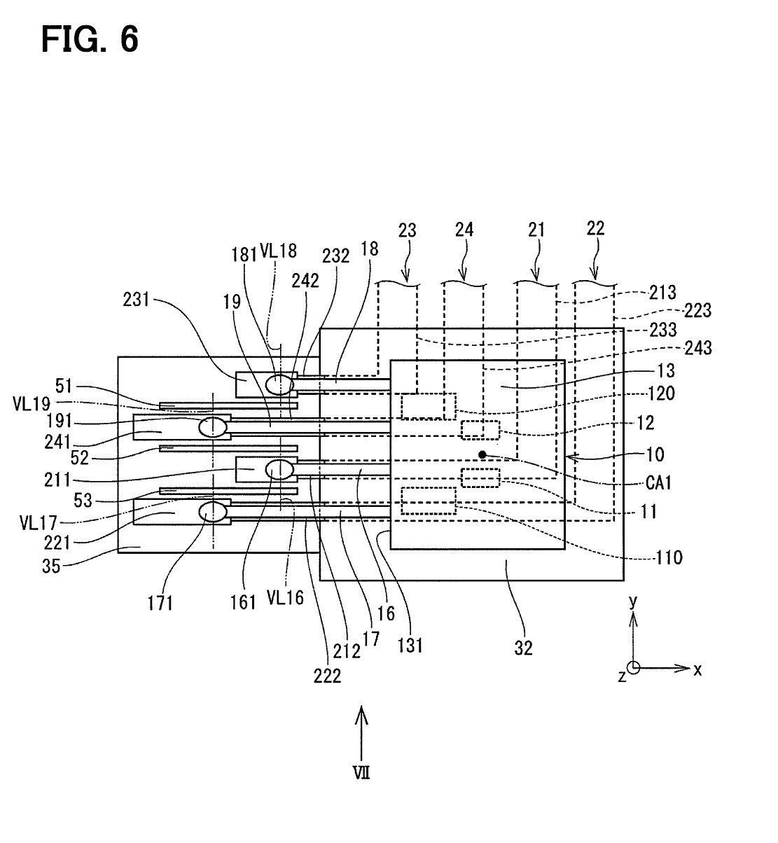

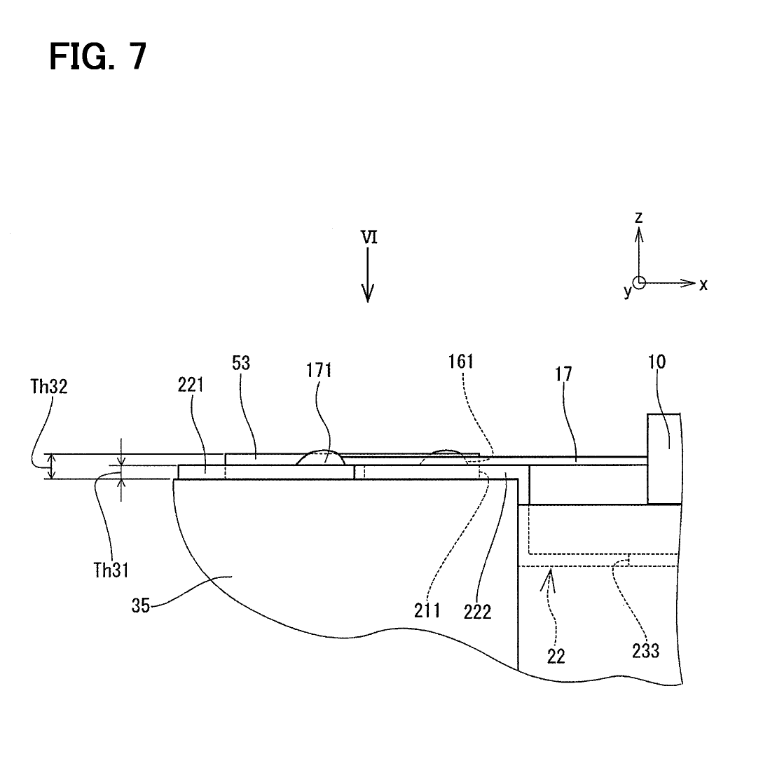

A position detection device according to a third embodiment will be described with reference to FIGS. 6 and 7. The third embodiment is different from the second embodiment in the shape of wall bodies.

A partial enlarged view of a rotation angle detection device according to a third embodiment is illustrated in FIG. 6. The rotation angle detection device according to the third embodiment includes the IC package 10, the sensor terminal 20, the motor terminal 25, the sensor housing 30, a cover 51, and covers 52 and 53 as “the wall bodies”.

The covers 51, 52, and 53 are portions, formed integrally with the sensor housing 30, that are made of resin material. The covers 51, 52, and 53 are provided on the placement table 35.

The cover 51 is formed so as to extend along the ground lead line 19 from the side of the ground welding terminal 241 positioned in the positive direction of the y-axis to the side of the second signal welding terminal 231 positioned in the negative direction of the y-axis. The height of the cover 51 along the z-axis is larger than the height of the ground welding terminal 241 along the z-axis and the height of the second signal welding terminal 231 along the z-axis. The height of the cover 51 along the z-axis is preferably larger than the height along the z-axis when the ground lead line 19 and the ground welding terminal 241 overlap with each other and the height along the z-axis when the second signal welding terminal 231 and the second signal lead line 18 overlap with each other.

The cover 52 is formed so as to extend along the ground lead line 19 from the side of the ground welding terminal 241 positioned in the negative direction of the y-axis to the side of the power supply welding terminal 211 positioned in the positive direction of the y-axis. That is, the ground lead line 19 is sandwiched between the cover 51 and the cover 52. The height of the cover 52 along the z-axis is larger than the height of the ground welding terminal 241 along the z-axis and the height of the power supply welding terminal 211 along the z-axis. The height of the cover 52 along the z-axis is preferably larger than the height along the z-axis when the ground welding terminal 241 and the ground lead line 19 overlap with each other and the height along the z-axis when the power supply welding terminal 211 and the power supply lead line 16 overlap with each other.

The cover 53 is formed so as to extend along the first signal lead line 17 from the side of the first signal welding terminal 221 positioned in the positive direction of the y-axis to the side of the power supply welding terminal 211 positioned in the negative direction of the y-axis. That is, the power supply lead line 16 on the power supply welding terminal 211 is sandwiched between the cover 52 and the cover 53. The height of the cover 53 along the z-axis is larger than the height of the first signal welding terminal 221 along the z-axis and the height of the power supply welding terminal 211 along the z-axis. Specifically, as illustrated in FIG. 7, which is a partial enlarged view seen from the direction of the arrow VII in FIG. 6, a height Th32 of the cover 53 along the z-axis is larger than a height Th31 of the first signal welding terminal 221 along the z-axis. The height of the cover 53 along the z-axis is preferably larger than the height along the z-axis when the first signal welding terminal 221 and the first signal lead line 17 overlap with each other and the height along the z-axis when the power supply welding terminal 211 and the power supply lead line 16 overlap with each other.

In the rotation angle detection device according to the third embodiment, the covers 51, 52, and 53 configured to avoid attachment of spatters are provided not only the periphery of the welding terminals, but also the periphery of the lead lines. Accordingly, the third embodiment can surely restrict occurrence of a short circuit of a combination of a lead line and a terminal line that do not correspond to each other in addition to obtaining the effects of the first embodiment.

In addition, in the rotation angle detection device according to the third embodiment, two covers are provided to sandwich one lead line. This enables to restrict the deformation of lead lines, thereby surely restricting a short cut between adjacent lead lines.

### Other Embodiments

In the embodiment described above, the position detection device is applied to the electronic control throttle device that controls the amount of intake air supplied to the engine installed in the vehicle. However, the field to which the position detection device is applied is not limited to these examples.

In the embodiment described above, the length of the first signal lead line is the same as that of the ground lead line. In addition, the length of the power supply lead line is the same as that of the second signal lead line. However, the relationship between the lengths of the lead lines is not limited to these examples. When the end face of the sealing portion from which the lead lines project is formed in a planar shape, the length of one lead line only needs to be different from the length of another lead line adjacent to the one lead line.

In the embodiments described above, “the first lead line” is the power supply lead line and “the second lead line” is the first signal lead line or the ground lead line. However, “the first lead line” and “the second lead line” are not limited to the examples. When “the first lead line” is the first signal lead line, “the second lead line” is the power supply lead line. Alternatively, when “the first lead line” is the ground lead line, “the second lead line” is the power supply lead line or the second signal lead line. Alternatively, when “the first lead line” is the second signal lead line, “the second lead line” is the ground lead line.

In the embodiments described above, “the first terminal line” is the power supply terminal line and “the second terminal line” is the first signal terminal line or the ground terminal line. However, “the first terminal line” and “the second terminal line” are not limited to the examples. When “the first terminal line” is the first signal terminal line, “the second terminal line” is the power supply terminal line. Alternatively, when “the first terminal line” is the ground terminal line, “the second terminal line” is the power supply terminal line or the second signal terminal line. Alternatively, when “the first terminal line” is the second signal terminal line, “the second terminal line” is the ground terminal line.

In the embodiments described above, “the first welding portion” is the welding portion between the power supply lead line and the power supply welding terminal and “the second welding portion” is the welding portion between the first signal lead line and the first signal welding terminal or the welding portion between the ground lead line and the ground welding terminal. However, “the first welding portion” and “the second welding portion” are not limited to the examples. When “the first welding portion” is the welding portion between the first signal lead line and the first signal welding terminal, “the second welding portion” is the welding portion between the power supply lead line and the power supply welding terminal. Alternatively, when “the first welding portion” is the welding portion between the ground lead line and the ground welding terminal, “the second welding portion” is the welding portion between the power supply lead line and the power supply welding terminal or the welding portion between the second signal lead line and the second signal welding terminal. Alternatively, when “the first welding portion” is the welding portion between the second signal lead line and the second signal welding terminal, “the second welding portion” is the welding portion between the ground lead line and the ground welding terminal.

In the embodiments described above, “the first welding terminal” is the power supply welding terminal and “the second welding terminal” is the first welding terminal and the ground welding terminal. However, “the first welding terminal” and “the second welding terminal” are not limited to the examples. When “the first welding terminal” is the first signal welding terminal, “the second welding terminal” is the power supply welding terminal. Alternatively, when “the first welding terminal” is the ground welding terminal, “the second welding terminal” is the power supply welding terminal and the second signal welding terminal. Alternatively, when “the first welding terminal” is the second signal welding terminal, “the second welding terminal” is the ground welding terminal.

In the second embodiment, “the wall bodies” are the covers 45 and 46. Alternatively, in the third embodiment, “the wall bodies” are the covers 52 and 53. However, “the wall bodies” are not limited to the example. The covers 41, 42, 43, and 44 may be “the wall bodies”. The cover 51 may be “the wall body”.

In the embodiments described above, the IC package has four lead lines. The number of lead lines only needs to be two or more.

In the first embodiment, the power supply welding terminal and the second signal welding terminal do not overlap with the first signal welding terminal and the ground welding terminal along the x-axis. However, the power supply welding terminal and the second signal welding terminal may overlap with the first signal welding terminal and the ground welding terminal.

In the second embodiment, six covers are provided. In the third embodiment, three covers are provided. The number of covers is not limited to these examples. The number of covers may be one.

In the second embodiment, the cover 45 and the cover 46 are provided so as to sandwich the power supply lead line 16 on the power supply welding terminal 211. In the third embodiment, the cover 52 and the cover 53 are provided so as to sandwich the power supply lead line 16 on the power supply welding terminal 211. However, the two covers may further extend along the direction of the sealing portion 13 so as to sandwich the lead lines between the welding terminal and the sealing portion.

In the embodiments described above, the sensor terminal is formed so that one end portions connected to the lead lines are substantially parallel with the other end portions positioned in the connector portion, as illustrated in FIG. 2. However, the shape of the sensor terminal is not limited to these examples.

In the embodiments described above, the length of the first signal lead line is the same as that of the ground lead line. In addition, the length of the power supply lead line is the same as that of the second signal lead line. However, the length of the first signal lead line does not need to be the same as that of the ground lead line and the length of the power supply lead line does not need to be the same as that of the second signal lead line.

In the embodiments described above, the position detection device has the motor terminal capable of supplying electric power to the motor. However, the motor terminal may be absent.

In the embodiments described above, the IC package is a two-system output type having two magnetic detection elements. However, the IC package may have only one magnetic detection element or three or more magnetic detection elements.

In the embodiments described above, the IC package has the first signal processing circuit and the second signal processing circuit. However, the IC package may have neither the first signal processing circuit nor the second signal processing circuit. In addition, in the IC package, the first magnetic detection element is provided separately from the first signal processing circuit or the second magnetic detection element is provided separately from the second signal processing circuit. The first magnetic detection element may be integrated with the first signal processing circuit or the second magnetic detection element may be integrated with the second signal processing circuit.

The magnetic detection element according to the above embodiment may be a magnetic detection element such as a hall element or an MR element that only needs to output a signal that depends on a component of a magnetic field or the strength of the component.

In the embodiments described above, the lead lines are electrically connected to the terminal lines by welding. The welding may be resistance welding or laser welding.

The present disclosure is not limited to these embodiments and may be practiced in various forms without departing from the spirit of the present disclosure.

While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

1. A position detection device configured to detect a position of a detection target, comprising:
an IC package including
a magnetic detection element configured to output a signal that depends on a direction or a strength of an ambient magnetic field,
a sealing portion in which the magnetic detection element is sealed, and
a plurality of lead lines projected from the sealing portion and electrically connected to the magnetic detection element; and
a plurality of terminal lines weldable to the plurality of lead lines respectively, wherein
a first welding portion, in which a first lead line of the plurality of lead lines is welded to a first terminal line of the plurality of terminal lines, is present in a position not on vertical lines that pass through second welding portions in which second lead lines of the plurality of lead lines are welded to second terminal lines of the plurality of terminal lines respectively,
the second lead lines are adjacent to the first lead line, and
the vertical lines are orthogonal to center axes of the second lead lines respectively.

2. The position detection device according to claim 1, further comprising:
a wall body provided on a vertical line, which passes through the first welding portion and is orthogonal to a center axis of the first lead line.

3. The position detection device according to claim 2, wherein
the wall body extends along the second lead lines.

4. The position detection device according to claim 1, wherein
a first welding terminal of the first terminal line, to which the first lead line is weldable, is present in a position not on vertical lines that pass through second welding terminals of the second terminal lines, to which the second lead lines are weldable, the vertical lines being orthogonal to the center axes of the second lead lines.

5. The position detection device according to claim 1, wherein
the second terminal lines include second welding terminals, to which the second lead lines are weldable respectively, and second connection portions connected to the second welding terminals respectively, and
widths of the second welding terminals along the vertical lines are larger than widths of the second connection portions along the vertical lines.
